(19) United States
(12) Patent Application Publication
(10) Pub. No.: US 2018/0297216 A1
(43) Pub. Date: Oct. 18, 2018

(54) UNIVERSAL COUPLING AND ROBOT JOINT STRUCTURE

(71) Applicant: THK CO., LTD., Tokyo (JP)

(72) Inventor: Masaki NAGATSUKA, Tokyo (JP)

(21) Appl. No.: 15/762,372

(22) PCT Filed: Oct. 3, 2016
(86) PCT No.: PCT/JP2016/079216

§ 371 Date: Mar. 22, 2018

(30) Foreign Application Priority Data
Oct. 22, 2015 (JP) 2015-208194

(51) Int. Cl. B25J 17/02

(52) U.S. Cl. CPC B25J 17/025

(57) ABSTRACT

A universal coupling is provided which can have a wide range of motion of a second member with respect to a first member. The universal coupling is provided with a bearing having an outer ring and an inner ring relatively rotatable about a center line with respect to the outer ring. A shaft that is square to the center line of the bearing is fixed to the inner ring of the bearing. The shaft supports an arm in such a manner as to be rotatable about the shaft. The bearing is connected to the first member. The arm is connected to the second member.

### TECHNICAL FIELD

The present invention relates to a universal coupling that swingably connects a first member and a second member, and a robot joint structure using the universal coupling.

### BACKGROUND ART

A universal coupling including a first yoke connected to a first member, a cross-shaped shaft including a first and a second shaft orthogonal to each other, and a second yoke connected to a second member is known as a known typical universal coupling (refer to Patent Literature 1). The first yoke has a bifurcated distal end. The bifurcated distal end of the first yoke is rotatably connected to the first shaft of the cross-shaped shaft. The second yoke also has a bifurcated distal end. The bifurcated distal end of the second yoke is rotatably connected to the second shaft of the cross-shaped shaft. The first and second yokes are swingably connected via the cross-shaped shaft.

### CITATION LIST

### Patent Literature

Patent Literature 1: JP 2002-276683 A

### SUMMARY OF INVENTION

### Technical Problem

However, the known universal coupling has a problem that the range of motion of the second member with respect to the first member is limited to a range where the first yoke does not come into contact with the second yoke, and it is not possible to have a wide range of motion of the second member with respect to the first member.

Hence, an object of the present invention is to provide a universal coupling that can have a wide range of motion of a second member with respect to a first member, and a robot joint structure using the universal coupling.

### Solution to Problem

To solve the above problem, the present invention is a universal coupling for swingably connecting a first member and a second member, the universal coupling including: a bearing including an outer ring and an inner ring relatively rotatable about a center line with respect to the outer ring, the bearing being configured to be connectable to the first member; a shaft that is fixed to the inner ring or the outer ring and is square to the center line; and an arm supported by the shaft in such a manner as to be rotatable about the shaft, the arm being configured to be connectable to the second member.

### Advantageous Effects of Invention

According to the present invention, it is possible to have a wide range of rotation of an arm about a center line of a bearing. Accordingly, it is possible to have a wide range of motion of a second member with respect to a first member. Moreover, it is encouraged to make a universal coupling compact, and the stiffness of the universal coupling is improved.

### BRIEF DESCRIPTION OF DRAWINGS

FIG. 1 is an external perspective view of a universal coupling in a first embodiment of the present invention.

FIG. 2 is an exploded perspective view of the universal coupling of the embodiment.

FIGS. 3A and 3B are detailed views of the universal coupling of the embodiment (FIG. 3A is aside view of the universal coupling, and FIG. 3B is an A-A cross-sectional view of FIG. 3A).

FIG. 4 is a cross-sectional view of a bearing.

FIG. 5 is a schematic diagram of rollers incorporated in the bearing.

FIG. 6 is a perspective view of a human-type robot where the universal couplings of the embodiment are incorporated.

FIG. 7 is a perspective view of an ankle joint where the universal coupling of the embodiment is incorporated.

FIG. 8 is a side view of the ankle joint where the universal coupling of the embodiment is incorporated.

FIG. 9 is a perspective view of a universal coupling in a second embodiment of the present invention.

### DESCRIPTION OF EMBODIMENTS

A universal coupling in embodiments of the present invention is described in detail hereinafter on the basis of the accompanying drawings. However, the present invention can be embodied in various modes, and is not limited to the embodiments described in the description. The description is fully disclosed to provide the embodiments with the intention of causing those skilled in the art to fully understand the scope of the invention. In the accompanying drawings, the same reference numerals are assigned to the same components.

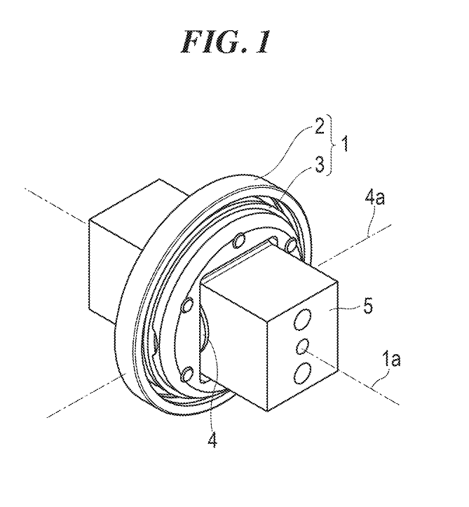

FIG. 1 illustrates an external perspective view of a universal coupling in a first embodiment of the present invention. The universal coupling of the embodiment includes a bearing 1 having an outer ring 2 and an inner ring 3, a shaft 4 fixed to the inner ring 3 of the bearing 1, and an arm 5 supported by the shaft 4 in such a manner as to be rotatable about the shaft 4. The bearing 1 is connected to an unillustrated first member. The arm 5 is connected to an unillustrated second member. The inner ring 3 is rotatable about a center line 1a with respect to the outer ring 2. The shaft 4 is square to the center line 1a of the bearing 1. A center line 4a of the shaft 4 and the center line 1a of the bearing 1 are orthogonal to each other. Therefore, the universal coupling connects the first member and the second member in such a manner that the second member can swing about the two orthogonal center lines 1a and 4a with respect to the first member.

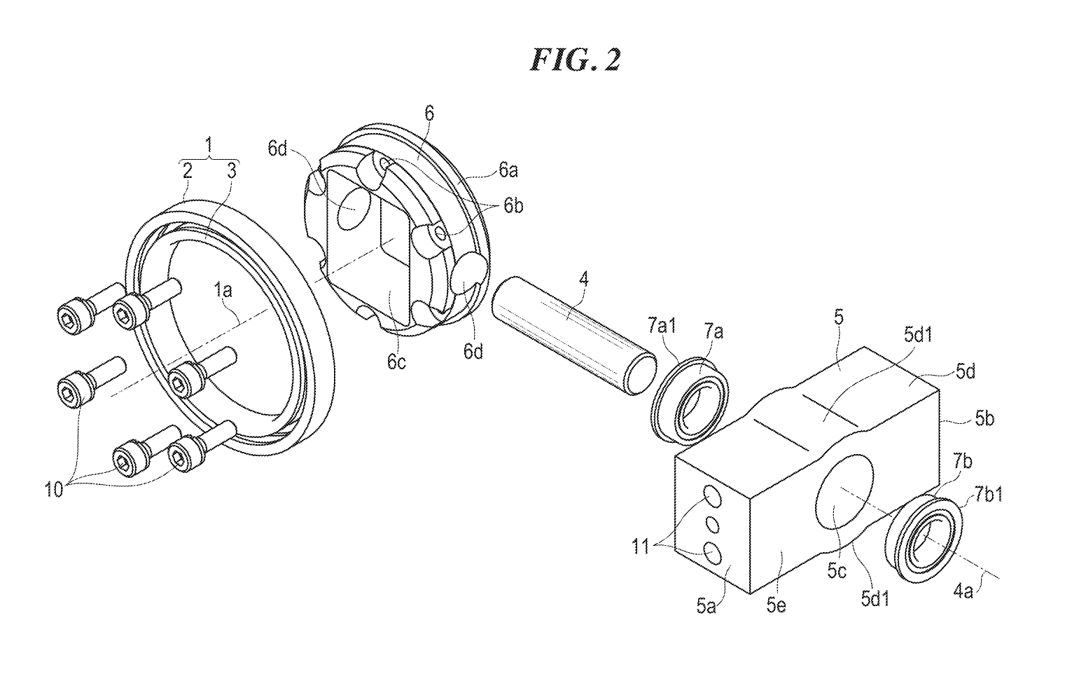

FIG. 2 illustrates an exploded perspective view of the universal coupling. In FIG. 2, the reference numeral 1 denotes the bearing, a reference numeral 6 a block, the reference numeral 4 the shaft, the reference numeral 5 the arm, and reference numerals 7a and 7b arm bearings. They are described in turn below.

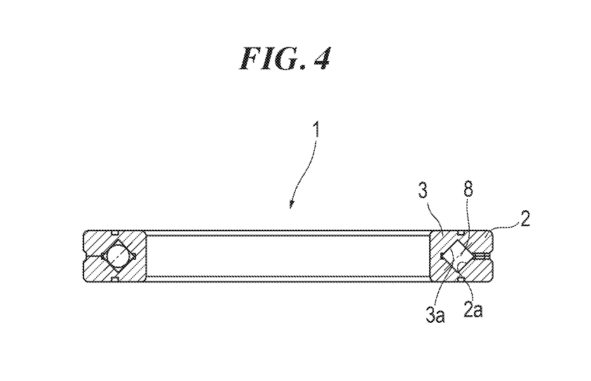

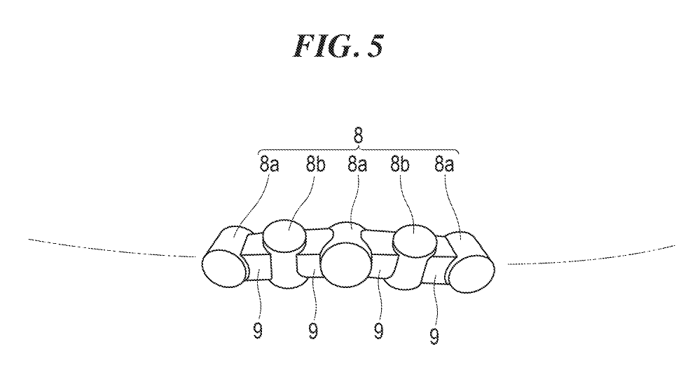

The bearing 1 is a cross roller bearing where a plurality of rollers is placed between the outer ring 2 and the inner ring 3 in such a manner that adjacent roller axes are orthogonal to each other. As illustrated in a cross-sectional view of FIG. 4, the outer ring 2 has, on its inner peripheral surface, a roller rolling surface 2a with a V-shaped cross section. The inner ring 3 has, on its outer peripheral surface, a roller rolling surface 3a with a V-shaped cross section, the roller rolling surface 3a facing the roller rolling surface 2a. An annular roller rolling path with a rectangular cross section is formed between the outer ring 2 and the inner ring 3. As illustrated in FIG. 5, a plurality of rollers 8 is placed in the roller rolling path in such a manner that the axes of adjacent rollers 8a and 8b are orthogonal to each other. A spacer 9 that prevents the adjacent rollers 8a and 8b from coming into contact with each other is interposed between the rollers 8. When the inner ring 3 is rotated with respect to the outer ring 2, the plurality of rollers 8 interposed between the outer ring 2 and the inner ring 3 performs rolling motion along the roller rolling path. The use of the cross roller bearing allows the load-carrying capacity to improve. Even the single bearing 1 can receive a heavy axial load, radial load, and moment load.

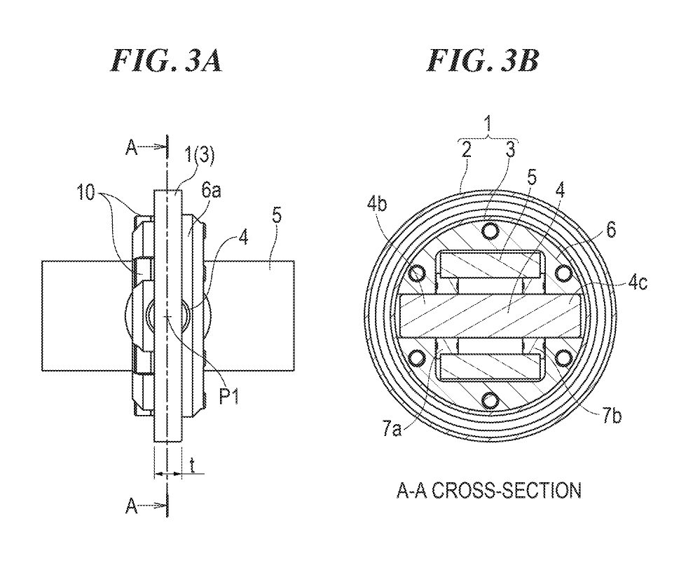

As illustrated in FIG. 2, the substantially short cylindrical block 6 is fitted in the inner ring 3. The block 6 is fastened to the inner ring 3 by a fastening member 10 such as a bolt. The block 6 is provided at one end in a direction of the center line 1a with a flange 6a. The block 6 is provided with a screw hole 6b that is threadedly engaged with the fastening member 10. When the block 6 is fitted in the inner ring 3 and the fastening member 10 is threadedly attached to the block 6, the inner ring 3 is sandwiched between the head of the fastening member 10 and the flange 6a (refer to a side view of FIG. 3A).

As illustrated in FIG. 2, the block 6 includes an opening 6c with a square cross section, the opening 6c penetrating the block 6 in the direction of the center line 1a of the bearing 1. The opening 6c is placed in the center of the block 6 in front view of the block 6. Moreover, the block 6 includes shaft fixing holes 6d and 6d extending in a direction orthogonal to the center line 1a of the bearing 1 and communicating with the opening 6c. The shaft 4 is fitted in the shaft fixing holes 6d and 6d. The shaft 4 has a circular cylindrical shape. The shaft 4 is fixed at both axial ends to the block 6 (refer to a cross-sectional view of FIG. 3B).

As illustrated in FIG. 2, the arm 5 has a substantially square cross section smaller than the opening 6c of the block 6, and extends in a direction orthogonal to the shaft 4. The arm 5 is inserted in the opening 6c of the block 6, and penetrates the block 6. The block 6 permits the rotation of the arm 5 inside the opening 6c. The arm 5 can rotate until coming into contact with an edge of the opening 6c of the block 6. The range of rotation of the arm 5 is restricted by the edge of the opening 6c of the block 6. Both ends 5a and 5b in a length direction of the arm 5 protrude from the block 6. The both ends 5a and 5b in the length direction of the arm 5 are provided with screw holes 11 as mounting portions for mounting the arm 5 on the second member.

The arm 5 has, in the center in the length direction, a through hole 5c where the shaft 4 penetrates. The arm 5 includes bulging portions 5d1 and 5d1 that bulge in an arc shape out of side surfaces 5d and near the through hole 5c. The bulging portions 5d1 and 5d1 are provided to provide a level difference from the side surfaces 5d. Accordingly, it is possible to have a wide range of rotation of the arm 5 about the shaft 4. The arm 5 is fitted to the outside of the shaft 4. The two arm bearings 7a and 7b are interposed between the shaft 4 and the arm 5. The two arm bearings 7a and 7b are placed, spaced apart in an axial direction of the shaft 4. The arm bearings 7a and 7b are ball bearings each including an outer ring, an inner ring, and multiple balls capable of rolling motion between the outer ring and the inner ring. Flanges 7a1 and 7b1 for bringing side surfaces 5e of the arm 5 into contact with the arm bearings 7a and 7b are provided to the outer rings. As illustrated in the cross-sectional view of FIG. 3B, the arm 5 is placed between both ends 4b and 4c of the shaft 4 fixed to the block 6.

As illustrated in FIG. 3A, the center of the shaft 4, that is, a center P1 of rotation of the arm 5 about the shaft 4, is placed within a range of the thickness of the bearing 1 in the direction of the center line 1a of the bearing 1 when viewed from the side of the universal coupling.

The universal coupling of the embodiment takes the following effects:

It is possible to have a wide range of rotation of the arm 5 about the center line 1a of the bearing 1. Accordingly, it is possible to have a wide range of motion about the center line 1a of the second member with respect to the first member. However, the range of rotation about the center line 4a of the arm 5 is restricted by the contact of the arm 5 with the edge of the opening 6c of the block 6. Hence, the range of rotation about the center line 4a of the arm 5 is smaller than the range of rotation about the center line 1a. The universal coupling of the embodiment is suitable for a universal coupling for applications where the range of rotation about the center line 1a being one of the two orthogonal center lines 1a and 4a is wider than the range of rotation about the other center line 4a.

The block 6 having the opening 6c is fixed to the inner ring 3, and the rotation of the arm 5 is permitted inside the opening 6c of the block 6. Accordingly, it is possible to make the universal coupling compact.

Both axial ends 4b and 4c of the shaft 4 are fixed to the block 6. Accordingly, the shaft 4 can be stably fixed, and the stiffness of the universal coupling is improved.

The center P1 of rotation of the arm 5 about the shaft 4 is placed within a range of a thickness t of the bearing 1 in the direction of the center line 1a of the bearing 1 when viewed from the side of the universal coupling. Accordingly, the bearing 1 can stably receive a load acting on the arm 5, and the stiffness of the universal coupling is improved.

The cross roller bearing is used for the bearing 1. Accordingly, the load-carrying capacity of the bearing 1 is improved, and the stiffness of the universal coupling is improved.

At least two arm bearings 7a and 7b are interposed between the shaft 4 and the arm 5, spaced apart in the axial direction of the shaft 4. Accordingly, the rotation of the arm 5 is stabilized, and the stiffness of the universal coupling is improved.

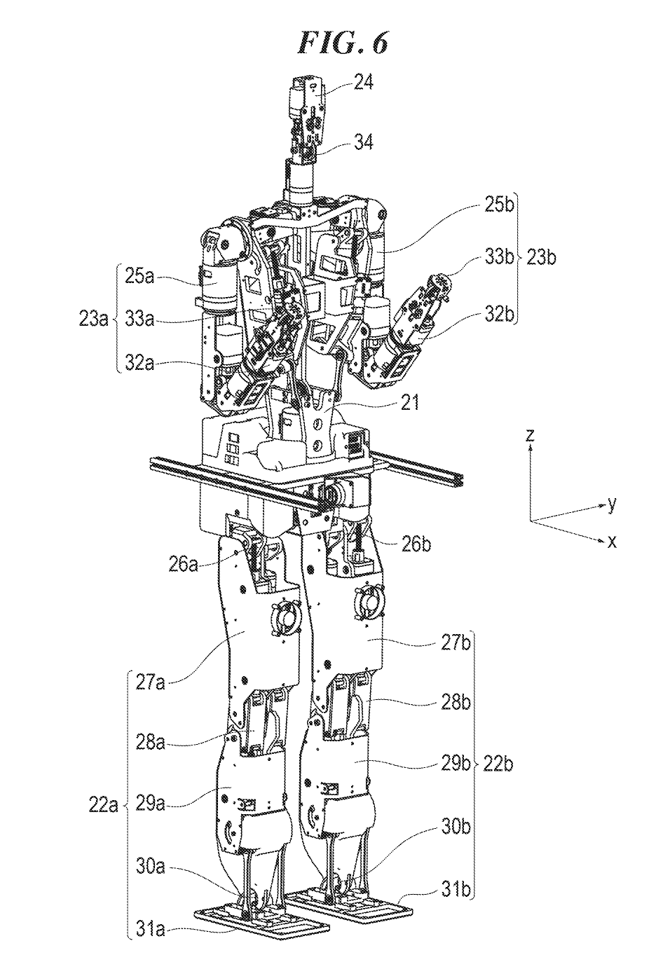

FIG. 6 illustrates a perspective view of a human-type robot where the universal couplings of the embodiment are incorporated. The human-type robot includes a body section 21, two leg sections 22a and 22b mounted under the body section 21, two arm sections 23a and 23b mounted on both of upper left and right side surfaces of the body section 21, and one head section 24 mounted on the body section 21 (in reality, a head section where a CCD camera is mounted is fixed to a member of the reference numeral 24). The human-type robot is configured in such a manner as to be able to perform actions close to the actions of a human. In the following description, left and right are left and right when viewed from the human-type robot. Moreover, when the travel direction of the human-type robot is an x-axis positive direction, the left direction as viewed from the human-type robot is a y-axis positive direction, and the upward direction of the human-type robot is a z-axis positive direction, the x axis is the roll axis, the y axis is the pitch axis, and the z axis is the yaw axis.

The human-type robot is a bipedal robot, and walks keeping its balance on two legs like a human. The leg sections 22a and 22b are connected to the body section 21 via hip joints 26a and 26b. The hip joints 26a and 26b connect the body section 21 and the leg sections 22a and 22b in such a manner that the leg sections 22a and 22b are swingable about the pitch and roll axes with respect to the body section 21.

Femoral sections 27a and 27b are connected to the hip joints 26a and 26b. Shank sections 29a and 29b are connected to lower sides of the femoral sections 27a and 27b via knee joints 28a and 28b. Foot sections 31a and 31b that touch a walking road surface are connected to lower sides of the shank sections 29a and 29b via ankle joints 30a and 30b. The ankle joints 30a and 30b connect the shank sections 29a and 29b and the foot sections 31a and 31b in such a manner that the foot sections 31a and 31b are swingable about the pitch and roll axes with respect to the shank sections 29a and 29b.

The two arm sections 23a and 23b are designed to be freely movable around the body section 21. The arm sections 23a and 23b include upper arm sections 25a and 25b closer to the shoulders, and lower arm sections 32a and 32b closer to unillustrated hand sections, across the elbows. The hand sections are connected to distal ends of the lower arm sections 32a and 32b via wrist joints 33a and 33b. The wrist joints 33a and 33b connect the lower arm sections 32a and 32b and the hand sections in such a manner that the hand sections are swingable about the pitch and roll axes.

The head section 24 is connected to the body section 21 via a neck joint 34. The neck joint 34 connects the body section 21 and the head section 24 in such a manner that the head section 24 is swingable about the yaw and pitch axes with respect to the body section 21.

The universal couplings of the embodiment are incorporated in the hip joints 26a and 26b, the ankle joints 30a and 30b, the wrist joints 33a and 33b, and the neck joint 34 of the human-type robot. The range of rotation about one of the axes (for example, the pitch axis) of these joints is wider than the range of rotation of the other axis (for example, the roll axis). The center line 1a of the bearing 1 of the universal coupling is used as the one axis (for example, the pitch axis) whose range of rotation is wide, and the shaft 4 of the universal coupling is used as the other axis (for example, the roll axis) whose range of rotation is narrow.

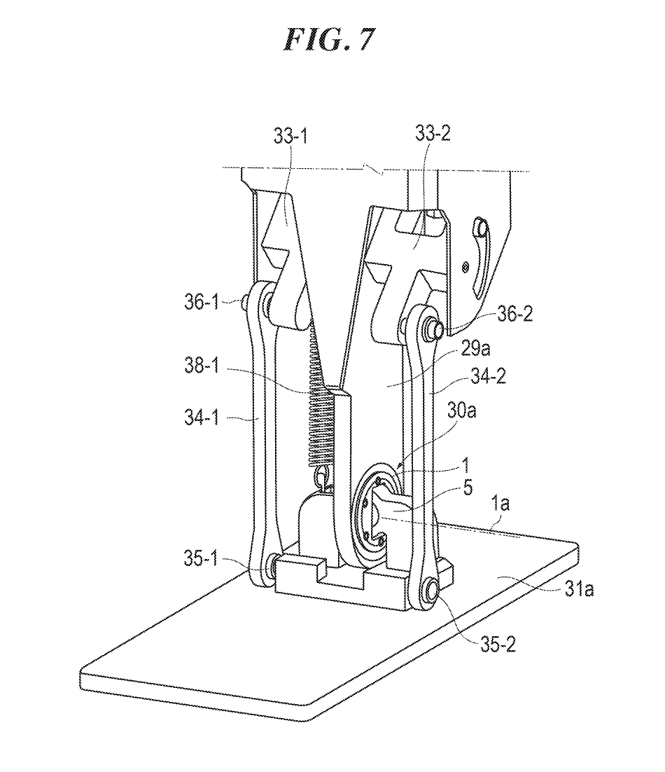

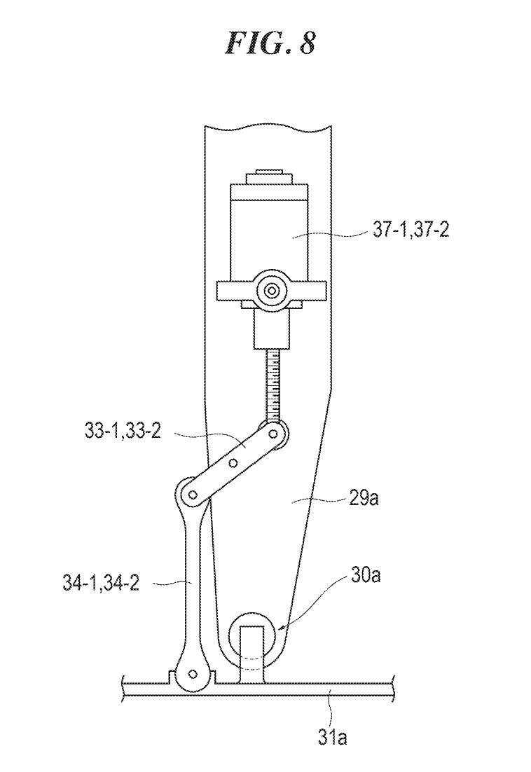

FIGS. 7 and 8 illustrate the ankle joint 30a where the universal coupling of the embodiment is incorporated. FIG. 7 illustrates a perspective view of the ankle joint 30a. FIG. 8 illustrates a side view of the ankle joint 30a when viewed from the pitch axis direction. As illustrated in FIG. 7, the outer ring 2 of the bearing 1 is fixed to the shank section 29a. The arm 5 of this example as a whole has an inverted U shape. The foot section 31a is fixed to both ends of the arm 5. The range of rotation about the pitch axis is wider at the ankle joint 30a than the range of rotation about the roll axis. Hence, the center line 1a of the bearing 1 is used as the pitch axis, and the shaft 4 (refer to FIG. 1) is used as the roll axis.

In the embodiment, a differential link mechanism is used as a mechanism that actuates the foot section 31a. The differential link mechanism includes a first and a second intermediate link 33-1 and 33-2 that are bilaterally symmetric about the shank section 29a and rotatably supported by the shank section 29a, and a first and a second operation arm 34-1 and 34-2 rotatably connected at one ends to the foot section 31a via couplings 35-1 and 35-2 and at the other ends to the first and second intermediate links 33-1 and 33-2 via couplings 36-1 and 36-2.

As illustrated in FIG. 8, the first and second intermediate links 33-1 and 33-2 are rotatably connected at the centers to the shank section 29a. One ends of the first and second intermediate links 33-1 and 33-2 are rotatably connected to the first and second operation arms 34-1 and 34-2. The other ends of the first and second intermediate links 33-1 and 33-2 are rotatably connected to a first and a second linear actuator 37-1 and 37-2. The first and second intermediate links 33-1 and 33-2 are biased in one direction by a first and a second coil spring (only a first coil spring 38-1 is illustrated in FIG. 7).

The first and second linear actuators 37-1 and 37-2 are rotatably supported by the shank section 29a. The first and second linear actuators 37-1 and 37-2 each include a ball spring. When a motor rotates a nut of the ball spring, a screw shaft moves in the axial direction, and the first and second linear actuators 37-1 and 37-2 extend and contract. When the first and second linear actuators 37-1 and 37-2 extend or contract simultaneously, the foot section 31a rotates about the pitch axis with respect to the shank section 29a. One of the first and second linear actuators 37-1 and 37-2 extends and the other contracts, the foot section 31a rotates about the roll axis with respect to the shank section 29a.

According to the differential link mechanism of the embodiment, the first and second intermediate links 33-1 and 33-2 are interposed between the first and second linear actuators 37-1 and 37-2 and the first and second operation arms 34-1 and 34-2. Accordingly, a load acting on the foot section 31a can be temporally received by the first and second intermediate links 33-1 and 33-2. Hence, it is possible to prevent the load acting on the foot section 31a from acting directly on the first and second linear actuators 37-1 and 37-2, and prevent any undue force in directions other than the axial direction, such as a radial load, a twist, and moment, on the first and second linear actuators 37-1 and 37-2.

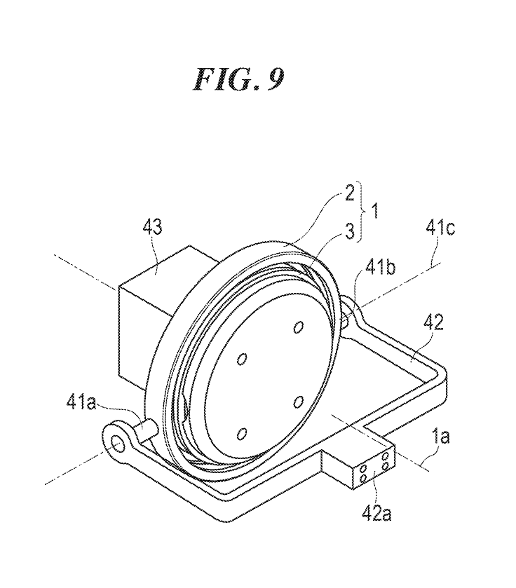

FIG. 9 illustrates a universal coupling in a second embodiment of the present invention. The universal coupling of the second embodiment includes the bearing 1, shafts 41a and 41b, and an arm 42 as in the universal coupling of the first embodiment. The configuration of the bearing 1 is the same as the universal coupling of the first embodiment. Accordingly, the same reference numerals are assigned and their description is omitted.

The first member is fixed to the outer ring 2 of the bearing 1 in the universal coupling of the first embodiment while a first member 43 is fixed to the inner ring 3 of the bearing 1 in the universal coupling of the second embodiment. The pair of shafts 41a and 41b is fixed to the outer periphery of the outer ring 2 of the bearing 1. The shafts 41a and 41b are connected to the arm 42 having a substantially U shape as a whole in such a manner as to be rotatable about the shafts 41a and 41b. The arm 42 is provided with a mounting portion 42a to be connected to the second member.

The outer ring 2 of the bearing 1 is rotatable about the center line 1a with respect to the inner ring 3. The arm 42 is rotatable about the shafts 41a and 41b. A center line 41c of the shafts 41a and 41b is orthogonal to the center line 1a of the bearing 1. Therefore, the universal coupling connects the first member 43 and the unillustrated second member in such a manner that the second member is swingable about the two orthogonal center lines 1a and 41c with respect to the first member 43.

The present invention is not limited to the realization of the embodiments, and can employ other embodiments within the scope that does not change the gist of the present invention.

For example, in the embodiments, a single cross roller bearing is used as the bearing. However, a plurality of roller bearings or a plurality of ball bearings can also be employed.

Moreover, in the embodiments, a ball bearing is used as the arm bearing. However, a plain bearing can also be used.

In the embodiments, the bearing is connected directly to the first member. However, the bearing can also be connected to the first member via a component such as a housing.

The universal coupling of the present invention is not limited to a human-type robot, but can be applied to various robots such as a parallel link robot and an industrial robot.

The description is based on Japanese Patent Application No. 2015-208194 filed on Oct. 22, 2015, the entire contents of which are incorporated herein.

### REFERENCE SIGNS LIST

1 Bearing
1a Center line of the bearing
2 Outer ring
3 Inner ring
4 Shaft
4a Center line of the shaft
4b, 4c Both ends of the shaft
5 Arm
5c Through hole of the arm
6 Block
6c Opening of the block
7a, 7b Arm bearing
8 Roller
8a, 8b Adjacent roller
21 Body section
30a, 30b Ankle joint of the robot
33a, 33b Wrist joint of the robot
34 Neck joint
41a, 41b Shaft
42 Arm
P1 Center of rotation of the arm with respect to the shaft

1. A universal coupling for swingably connecting a first member and a second member, the universal coupling comprising:
a bearing including an outer ring and an inner ring relatively rotatable about a center line with respect to the outer ring, the bearing being configured to be connectable to the first member;
a shaft that is fixed to the inner ring or the outer ring and is square to the center line; and
an arm supported by the shaft in such a manner as to be rotatable about the shaft, the arm being configured to be connectable to the second member.

2. The universal coupling according to claim 1, wherein
a block including an opening penetrating in a direction of the center line of the bearing is fixed to the inner ring, and
the block permits rotation of the arm about the shaft inside the opening.

3. The universal coupling according to claim 2, wherein the shaft is fixed at both ends in an axial direction to the block.

4. The universal coupling according to claim 1, wherein when viewed from the side of the universal coupling, a center of rotation of the arm about the shaft is placed within a range of a thickness of the bearing in the direction of the center line of the bearing.

5. The universal coupling according to claim 1, wherein the bearing is a cross roller bearing where a plurality of rollers is placed between the outer ring and the inner ring in such a manner that axes of the adjacent rollers are orthogonal.

6. The universal coupling according to claim 2, wherein at least two arm bearings that support the arm swingably are interposed between the shaft and the arm, spaced apart in the axial direction of the shaft.

7. A robot joint structure using the universal coupling according to claim 1, wherein
the bearing swings the second member about a first axis with respect to the first member,
the arm swings the second member about a second axis with respect to the first member, and
the range of rotation of the second member about the first axis is wider than the range of rotation about the second axis.

8. The universal coupling according to claim 2, wherein when viewed from the side of the universal coupling, a center of rotation of the arm about the shaft is placed within a range of a thickness of the bearing in the direction of the center line of the bearing.

9. The universal coupling according to claim 3, wherein when viewed from the side of the universal coupling, a center of rotation of the arm about the shaft is placed within a range of a thickness of the bearing in the direction of the center line of the bearing.

10. The universal coupling according to claim 2, wherein the bearing is a cross roller bearing where a plurality of rollers is placed between the outer ring and the inner ring in such a manner that axes of the adjacent rollers are orthogonal.

11. The universal coupling according to claim 3, wherein the bearing is a cross roller bearing where a plurality of rollers is placed between the outer ring and the inner ring in such a manner that axes of the adjacent rollers are orthogonal.

12. The universal coupling according to claim 4, wherein the bearing is a cross roller bearing where a plurality of rollers is placed between the outer ring and the inner ring in such a manner that axes of the adjacent rollers are orthogonal.

13. A robot joint structure using the universal coupling according to claim 2, wherein
the bearing swings the second member about a first axis with respect to the first member,
the arm swings the second member about a second axis with respect to the first member, and
the range of rotation of the second member about the first axis is wider than the range of rotation about the second axis.

14. A robot joint structure using the universal coupling according to claim 3, wherein
the bearing swings the second member about a first axis with respect to the first member,
the arm swings the second member about a second axis with respect to the first member, and
the range of rotation of the second member about the first axis is wider than the range of rotation about the second axis.

15. A robot joint structure using the universal coupling according to claim 4, wherein
the bearing swings the second member about a first axis with respect to the first member,
the arm swings the second member about a second axis with respect to the first member, and
the range of rotation of the second member about the first axis is wider than the range of rotation about the second axis.

16. A robot joint structure using the universal coupling according to claim 5, wherein
the bearing swings the second member about a first axis with respect to the first member,
the arm swings the second member about a second axis with respect to the first member, and
the range of rotation of the second member about the first axis is wider than the range of rotation about the second axis.

17. A robot joint structure using the universal coupling according to claim 6, wherein
the bearing swings the second member about a first axis with respect to the first member,
the arm swings the second member about a second axis with respect to the first member, and
the range of rotation of the second member about the first axis is wider than the range of rotation about the second axis.

18. A robot joint structure using the universal coupling according to claim 8, wherein
the bearing swings the second member about a first axis with respect to the first member,
the arm swings the second member about a second axis with respect to the first member, and
the range of rotation of the second member about the first axis is wider than the range of rotation about the second axis.

19. A robot joint structure using the universal coupling according to claim 9, wherein
the bearing swings the second member about a first axis with respect to the first member,
the arm swings the second member about a second axis with respect to the first member, and
the range of rotation of the second member about the first axis is wider than the range of rotation about the second axis.

20. A robot joint structure using the universal coupling according to claim 10, wherein
the bearing swings the second member about a first axis with respect to the first member,
the arm swings the second member about a second axis with respect to the first member, and
the range of rotation of the second member about the first axis is wider than the range of rotation about the second axis.
